(19) United States
(12) Patent Application Publication
(10) Pub. No.: US 2012/0145021 A1
(43) Pub. Date: Jun. 14, 2012

(54) ROLLERS FOR DAMPENING UNITS

(75) Inventor: Thorsten Pfeil, Koeln (DE)

(73) Assignee: Felix Boettcher GmbH & Co. KG, Koeln (DE)

(21) Appl. No.: 13/384,153

(22) PCT Filed: Jul. 14, 2010
(86) PCT No.: PCT/EP10/60147

§ 371 Date: Feb. 29, 2012

(30) Foreign Application Priority Data
Jul. 14, 2009 (EP) 09165365.9

(51) Int. Cl. B41L 23/02

(52) U.S. Cl. 101/148

(57) ABSTRACT

Roll in a dampening system, particularly a dampening contact roll or dampening transfer roll or dampening ductor, comprising a core and an outer layer, wherein the outer layer is selected from the group consisting of hard anodized aluminum, chemical nickel and aluminum oxide, obtainable by plasmachemical anodic oxidation, and combinations thereof.

The present invention relates to a roller used in a dampening unit, such as a dampening contact roller, dampening transfer roller or dampening ductor, and the use thereof in a dampening system.

Offset printing is an indirect printing method employed in newspaper printing, magazine printing, catalogue printing etc. In offset printing, a printing forme is prepared, typically a thin aluminum plate. The latter is mounted on a plate cylinder and is in contact with inking systems and dampening units in the printing machine. Lipophilic areas of the printing forme accept printing ink, while hydrophilic areas remain ink-free.

From the plate cylinder, the printing ink is transferred to the printing blanket, which is mounted on a blanket cylinder or offset cylinder. Then, the blanket cylinder transfers the ink to the medium to be printed with the aid of an impression cylinder or another blanket cylinder.

For the printing quality, it is critical that the printing forme be sufficiently provided with ink and dampening solution. A sufficient amount of dampening solution (water or aqueous-alcoholic mixtures) must be transferred to the printing forme to keep the hydrophilic areas free from ink. On the other hand, enough printing ink must be transferred to supply printing ink to the lipophilic areas.

Both the dampening units and the inking systems transfer dampening solution and ink or an ink-water emulsion, respectively, to the printing forme by means of rollers.

Typical dampening units include one or more rollers, wherein often rollers having a soft surface, for example, with an elastomer coat, are in contact with one or more hard rollers or other elastomer-coated rollers.

In a typical three-roller dampening unit, a soft dampening solution dip roller is in direct contact with the dampening solution supply. It collects dampening solution from the supply and transfers it to a hard roller. The hard roller transfers the film of dampening solution to the dampening forme roller.

The hard roller is referred to as a dampening contact roller, dampening transfer roller or dampening ductor. These three terms are used interchangeably in this text.

In a typical four-roller dampening unit, the dampening solution dip roller is a hard roller that transfers the dampening solution to a soft roller (dampening transfer roller or dampening solution metering roller) at first, which then transfers it to a hard dampening contact roller or dampening transfer roller, which finally transfers it to the dampening forme roller.

In dampening units, there are further rollers, for example, rider rollers, which serve for smoothing the film of dampening solution, or bridge rollers, which provide contact between the inking system and the dampening unit.

There are also systems in which the last dampening forme roller is at the same time also an ink forme roller.

In the following, all these rollers are subsumed under the term “rollers for dampening units”. Preferably, the rollers are hard rollers, i.e., rollers without an elastomer coat.

Usual materials for the surfaces of hard rollers in dampening units, such as dampening contact rollers or dampening transfer rollers, include chromium, ceramics and stainless steel.

DE-AS-1257170 describes methods for the hydrophilization of dampening rollers by creating a coat containing vinylsilane. The outer layer of the roller is made of a silane.

DE60120444T2 discloses blank plates, which are roughened, anodically oxidized aluminum plates. Such plates are mounted on rollers where no printing ink is to be transferred to the web to be printed.

One problem in the field of dampening units is the fact that a so-called ink film back split occurs. The dampening forme roller, which is in contact with the printing forme, is wetted with printing ink or a printing ink emulsion during operation. It will then transfer these successively backwards to the other rollers in the dampening unit as well, to both the dampening solution dip roller or dampening solution metering roller and the dampening contact roller or dampening transfer roller, so that ultimately a contamination of the dampening solution may even occur. The migration of the ink gradually results in ink build-up on the surfaces of the dampening rollers and impairment of the printing process. This usually requires the printing process to be stopped, and the equipment to be cleaned.

Despite many variants of elastomer coatings on the soft rollers and different surface designs of the hard rollers, the problem of ink film back split still has not been solved completely. Therefore, there is still a need for improved dampening units that will solve at least some of the known problems of the prior art.

Surprisingly, this object can be achieved by a roller used in a dampening unit, especially a dampening contact roller, dampening transfer roller or dampening ductor, having a core and an outer layer, wherein said outer layer is selected from:
hard anodized aluminum;
chemical (electroless) nickel;
aluminum oxide obtainable by plasma-chemical anodic oxidation; and combinations thereof.

The rollers according to the invention show a reduced ink film back split, improved or more uniform transfer of dampening solution, and/or are more easily cleaned.

According to the invention, a roller having an outer layer that is hard anodized aluminum, or a layer of chemical (electroless) nickel, or an aluminum oxide layer obtainable by plasma-chemical anodic oxidation is employed as a hard roller in a dampening unit, especially as a dampening contact roller, dampening ductor or dampening transfer roller.

Hard anodized aluminums are known to the skilled person. They are obtained by anodic oxidation in a cold acidic electrolyte. A protecting aluminum oxide layer is formed on the surface by the electric current. Aluminum and aluminum alloys may be employed as starting materials.

In one embodiment, a roller is used in which the whole roller consists of (mono-lithic) aluminum.

In another embodiment, the roller contains a core of a different material, for example, a steel core, a carbon fiber or glass fiber core or the like, and an outer shell of aluminum, which is anodized to form hard anodized aluminum.

In a preferred embodiment, further materials, for example, particles of PTFE (polytetrafluoroethylene) or silicon carbide, are incorporated in the outer layer when the hard anodized aluminum is prepared.

Chemical nickel is obtained by a process in which nickel is deposited by electro-less deposition from a solution of nickel ions and a reducing agent (typically hypophosphite). The process of depositing nickel layers on surfaces is known to the skilled person in principle.

Typically, a core selected from steel cores, aluminum cores and carbon fiber cores is used for this embodiment. In this case too, it is possible to incorporate particles of PTFE, other fluorine-containing polymers or silicon carbide into the outer layer.

Typically, by using phosphorus-containing chemical nickel reagents, phosphorus is also incorporated in the layer.

Another suitable outer layer is obtained by plasma-chemical coating. Thus, a work piece can be used as an anode with an external power source. During anodization, an oxygen plasma is discharged on the surface of the work piece, which is thereby molten to form two oxide ceramic layers predominantly consisting of corundum and boehmite; see also EP 0 545 230.

In principle, further particles, for example, fluoropolymers, may be incorporated in these layers as well. Corresponding methods are known to the skilled person from DE 42 39 391.

When hard anodized aluminum is used, the preferred layer thickness is from 5 to 200 μm, more preferably from 20 to 100 μm, even more preferably from 30 to 60 μm. For the hard anodized aluminum, a surface roughness of Rz=0.1 to 100 μm, preferably Rz=0.5 to 8 μm, is particularly suitable.

When an aluminum oxide (corundum, boehmite) is used, the preferred layer thickness is from 5 to 200 μm, more preferably from 20 to 100 μm, even more preferably from 30 to 60 μm. For the aluminum oxides (corundum, boehmite), a surface roughness of Ra=0.05 to 20.0 μm, preferably Ra=0.1 to 2.0 μm, is particularly suitable.

For a chemical nickel layer, the typical thickness is from 2 to 40 μm, preferably from 10 to 20 μm. A roughness of Rz=0.1 to 100 μm, preferably Rz=0.5 to 8 μm, is particularly suitable.

Another embodiment of the invention is a roller according to the invention as described above in which additionally a layer of PTFE or a fluorine-containing polymer is applied, i.e., the PTFE or other fluorine-containing polymer is not incorporated in the layer, but forms a separate layer.

The invention also relates to a dampening unit containing at least one roller according to the invention, and to the use of the roller according to the invention as a roller in a dampening unit, especially a dampening contact roller or dampening transfer roller.

Surprisingly, the rollers according to the invention show a good dampening solution transfer performance while the ink film back split is reduced.

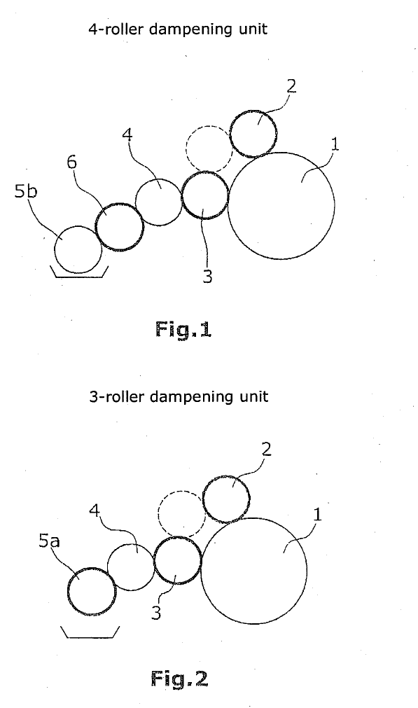

FIG. 1 schematically shows the structure of a four-roller dampening unit. The dampening solution dip roller (5b) is a hard roller that transfers the dampening solution to a soft roller (6) at first, which then transfers it to a hard dampening contact roller, dampening ductor or dampening transfer roller (4), which transfers it to the dampening forme roller (3), which finally transfers it to the plate cylinder (1). The plate cylinder is also in contact with the ink forme rollers (2).

FIG. 2 schematically shows the structure of a three-roller dampening unit. A soft dampening solution dip roller (5a) is in direct contact with the dampening solution supply. It collects dampening solution from the supply and transfers it to a hard dampening contact roller or dampening transfer roller (4). The hard roller (4) transfers the film of dampening solution to the dampening forme roller (3), which finally transfers it to the plate cylinder (1). The plate cylinder is also in contact with the ink forme rollers (2).

The invention is further illustrated by means of the following Examples.

### EXAMPLE 1

An aluminum roller with a useful coating length of 1110 mm and a diameter of 125 mm was provided with a layer of hard anodized aluminum having a thickness of 40 μm. When used in a three-roller dampening unit in a web offset press, it showed a very uniform transfer of dampening solution, and an improved dampening solution transfer performance as compared to a ceramic roller (the revolutions per minute could be reduced by 10%), while the ink film back split was reduced.

### EXAMPLE 2

An aluminum roller with a useful coating length of 530 mm and a diameter of 58 mm was provided with a layer of hard anodized aluminum having a thickness of 40 μm. When used in a three-roller dampening unit in a sheetfed offset press, it showed a very uniform transfer of dampening solution, and an improved dampening solution transfer performance.

### EXAMPLE 3

An aluminum roller with a useful coating length of 530 mm and a diameter of 58 mm was provided with a layer of PTFE-filled chemical nickel having a thickness of 15 μm. When used in a three-roller dampening unit in a sheetfed offset press, it showed a very uniform transfer of dampening solution, and an improved dampening solution transfer performance.

### EXAMPLE 4

An aluminum roller with a useful coating length of 530 mm and a diameter of 58 mm was provided with a layer of PTFE-filled hard anodized aluminum having a thickness of 40 μm. When used in a three-roller dampening unit in a sheetfed offset press, it showed a very uniform transfer of dampening solution, and an improved dampening solution transfer performance.

### EXAMPLE 5

An aluminum roller with a useful coating length of 530 mm and a diameter of 58 mm was provided with a layer of aluminum oxide (corundum, boehmite) having a thickness of 50 μm. When used in a three-roller dampening unit in a sheetfed offset press, it showed a very uniform transfer of dampening solution, and an improved dampening solution transfer performance.

### EXAMPLE 6

The rotation speeds of the rollers of Examples 2 to 5 and of a comparative roller of the prior art in a sheetfed offset press were set to obtain a good transfer of dampening solution. It was found that the rollers according to the invention can be operated at a lesser revolutions per minute, i.e., that they show a better transfer of dampening solution.

| | | Ra in | Rz in | Percent rotation speed |
|---|---|---|---|---|
| Outer layer | Core | μm | μm | of dampening ductor |
| Hard chromium | steel | 0.07 | 0.44 | 85% |
| Hard anodized aluminum | alu | 0.63 | 4.12 | 65% |
| (Example 2) | | | | |
| Chemical nickel with PTFE | alu | 0.79 | 5.81 | 70% |
| (Example 3) | | | | |
| Hard anodized aluminum + | alu | 1.08 | 6.14 | 68% |
| PTFE (Example 4) | | | | |
| Aluminum oxide | alu | 0.68 | 5.15 | 80% |
| (Example 5) | | | | |

1. A roller used in a dampening unit having a core and an outer layer, wherein said outer layer is selected from:
hard anodized aluminum;
chemical nickel;
aluminum oxide obtainable by plasma-chemical anodic oxidation;
and combinations thereof.

2. The roller according to claim 1, wherein particles of PTFE, other fluorine-containing polymers or silicon carbide are additionally incorporated in the outer layer.

3. The roller according to claim 1, wherein an outer layer of PTFE or another fluorine-containing polymer is applied to the roller.

4. The roller according to claim 1, wherein said core is selected from steel cores, aluminum cores, carbon fiber cores and glass fiber cores.

5. The roller according to claim 1, wherein the layer thickness of said layer of hard anodized aluminum is from 20 to 100 μm.

6. The roller according to claim 1, wherein said layer of hard anodized aluminum has a roughness of Rz=0.1 to 100 μm.

7. The roller according to claim 1, wherein said layer of chemical nickel contains from 2 to 15% by weight of phosphorus.

8. The roller according to claim 1, wherein the thickness of said layer of chemical nickel is from 2 to 40 μm.

9. The roller according to claim 1, wherein said layer of chemical nickel has a roughness of Rz=0.1 to 100 μm.

10. The roller according to claim 1, wherein the layer thickness of said aluminum oxide layer is from 5 to 200 μm.

11. The roller according to claim 1, wherein the roughness of said aluminum oxide layer is Ra=0.05 to 20.0 μm.

12. A dampening unit containing at least one roller according to claim 1.

13. Use of a roller according to claim 1 as a roller in a dampening unit.

14. The use according to claim 13, wherein said outer layer is a layer of hard anodized aluminum.

15. The use according to claim 13, wherein said outer layer is a chemical nickel layer.

16. The use according to claim 13, wherein said outer layer is an aluminum oxide layer obtainable by plasma-chemical anodic oxidation.

17. The use according to claim 14, wherein said layer of hard anodized aluminum has incorporated particles of PTFE, other fluorine-containing polymers or silicon carbide.

18. The use according to claim 15, wherein said chemical nickel layer has incorporated particles of PTFE, other fluorine-containing polymers or silicon carbide.

19. The use according to claim 16, wherein said outer aluminum oxide layer has incorporated particles of PTFE, other fluorine-containing polymers or silicon carbide.

20. The roller of claim 1, wherein the roller is a dampening contact roller, a dampening transfer roller or a dampening ductor.

21. The roller according to claim 5, wherein the layer thickness of said layer of hard anodized aluminum is from 30 to 60 μm.

22. The roller according to claim 6, wherein said layer of hard anodized aluminum has a roughness of Rz=0.5 to 8 μm.

23. The roller according to claim 8, wherein the thickness of said layer of chemical nickel is from 10 to 20 μm.

24. The roller according to claim 9, wherein said layer of chemical nickel has a roughness of Rz=0.5 to 8 μm.

25. The roller according to claim 10, wherein the layer thickness of said aluminum oxide layer is from 30 to 60 μm.

26. The roller according to claim 11, wherein the roughness of said aluminum oxide layer is Ra=0.1 to 2.0 μm.
